(19) United States
(12) Patent Application Publication
(10) Pub. No.: US 2003/0217367 A1
(43) Pub. Date: Nov. 20, 2003

(54) Wireless hand-held video, data, and audio transmission system

(76) Inventor: Harry A. Romano, Naples, FL (US)

Correspondence Address: Werner H. Schroeder, c/o IMRC Technologies, Inc., Suite 9, 4627 Arnold Ave., Naples, FL, 34104, US

(21) Appl. No.: 10/150,913

(22) Filed: May 20, 2002

(51) Int. Cl. H04N 7/173; H04N 7/20

(52) U.S. Cl. 725/118; 725/73

(57) ABSTRACT

The present invention is directed to a method and apparatus for wirelessly transmitting original signals from a first hand-held station to a second hand-held station in a duplex mode through a network by converting original signals in the first station to radio frequencies through a video-data-audio unit to a second video-data-audio module and thereafter impressing the signals into the air and these signals are received by another video-data-audio base station and then converted to digital signals by a pulse DSP in that module by passing those signals through a network and then transmitting the original signals to a video-data-audio unit in the second hand-held station and then displaying the results in that unit.

### CROSS REFERENCE TO RELATED APPLICATION

This application is a Utility application which is based on a provisional application Ser. No. 60/268,003 filed on Feb. 12, 2001.

### BACKGROUND OF THE INVENTION

The invention pertains to a wireless module, a microwave module, called a VDA™ (Video, Data, and Audio). This state of the art module could be compared to or is the next generation “Blue Tooth” or “802.11” module which is a digital protocol for a wireless module. The IM™=Interrupt modulation has been disclosed and claimed in applicants' U.S. Pat. No. 6,194,978.

It is believed that the innovative technology of the invention can impact most segments of the communication industry in a very competitive and profitable manner. It is anticipated to introduce products that will penetrate and saturate the entire communications environment whose products use IM™ and VDA™ technology as their transmission processes. Moreover, these unique technologies represent both stability breakthroughs with applications in virtually every aspect of the communications industry and can be deployed immediately without infrastructure change. Current wireless devices are slow and inconvenient to use. Furthermore, the greatest hindrance to deployment of new wireless services requires a major overhaul of the wireless infrastructure.

The innovative subject has solved these problems through the development of the VDA™ (Video, data, Audio) technology. The VDA™ technology consists of an extremely fast, versatile, fully duplexed hand-held digital video transceiver module. (A transceiver is a wireless device that transmits and receives information in the same device or module.) The VDA™ is capable of sending and receiving “real-time” full motion color video, digital audio, analog formats, and data simultaneously. The traditional wireless paradigm consists of a wireless device that talks to a tower. The tower then transfers multiple calls through a wired infrastructure and then on to its destination to other wireless infrastructures. Numerous technology companies are using this old paradigm for audio services successfully. However, companies are now attempting to send video and Internet based services using this antiquated method and are failing. For the deployment of videophones and other wireless services, a new solution must be created which was successfully done by the invention at hand. Many have focused on the 3G cell phone technology and Bluetooth as a solution. These companies are unable to deploy due to lack of supporting infrastructure (i.e. updating new towers and/or sites). The inventive concept before you has developed a new paradigm to solve this dilemma. This innovative concept uses existing networks and the Internet as vehicles of infrastructure. Thereby, the 3G-type products can be deployed immediately without the need of new infrastructures (i.e. new towers and/or sites). Every VDA™ system that is being installed anywhere, automatically becomes a wireless node (short-range wireless input to network infrastructure). As the surrounding nodes become clustered, it results in a wireless network with increased range of mobility. All of the existing wireless and future wireless devices are increasing in frequency and bandwidth. Physics dictates that the higher radio frequency used, the greater number of nodes is required in a mobile wireless network. Therefore, the innovative concept's paradigm becomes a viable solution to the next generation of communication technology. As 3G becomes available, (when the cost becomes more affordable) within the next ten years, the VDA™ technology will interconnect with it flawlessly because it will in effect become the new infrastructure required. In essence, a new infrastructure is being created.

The first technology developed in order to successfully produce high speed wireless data transfer is a modulation technique called Interrupt Modulation™ or IM™ for short. This technology is disclosed in applicant's U.S. Pat. No. 6,194,978.

A modulation technique is a way of mixing high-speed digital data with super high frequency radio signals. The new digital wireless technology, patented at 100MBPS (Mega Bits Per Second), has three distinct advantages over current modulation techniques.

These distinct advantages are a) higher speed data rates while maintaining reduced bandwidth b) ease of implementation, and c) lower costs. This technology is one of the base technologies in developing other products. IM™ has many potential applications throughout the wireless industry. The VDA-Module™ is a radio frequency transceiver device. It currently operates in the license-free ISM band, but can be implemented on any band. The VDA-Module™ currently can transmit and receive on any frequency between 2.1 GHz to 2.9 GHz. The VDA-Module™ operates in full duplex mode (duplex simultaneously transmits and receives information). It is classified as a fully duplexed 2.4 GHz microwave transceiver module. This module is capable of transmitting 30 frames per second color and high fidelity digital or analog audio, or 30 MBPS uncompressed raw binary data. It has an Ethernet interface so it can tie into existing and wired networks.

The VDA-Modules™ have been designed with enough memory to store its own individual Internet Protocol address (IP address) and/or a serial and PIN number). The memory has a capacity for additional information including diagnostics and logs. This information can be used for module identification in a network situation. Peripherals such as PC's, color and infrared cameras, large audio amplifiers, instruments, camcorders, and microphones can directly interface to the module. With the proper interface, other kinds of peripherals can be interfaced to the VDA-Module™ such as tanks, planes, missiles, aircraft carriers, boats, scanners, printers, fingerprint readers, seismographs, ATM's, robots, machines, and medical devices. Especially after the terror attack on the Twin Towers of the World Trade Center, the hand-held VDA-Unit™ would be extremely valuable. For example, if one unit is placed in the cockpit and additional units are in the flight cabin, such as in the hands of a flight attendant, or in strategic locations within the cabin. While the cockpit door is locked, the pilot is still aware of what is going on behind the locked door and can make a value decision. If the other planes have the same type of unit, they can dial a code into the system and immediately observe what is going on in a plane. The same is true in an airport tower having the VDA Unit™ available and being able to observe the goings on in the cockpit or cabin of the plane in question, simply by dialing the code number of the unit in that particular plane. The units that are subject to a patent of the application at hand have been tested and are in operation as prototypes.

The VDA-Module™ is the heart of a second inventive product, the VDA-Unit™. From the VDA-Module™, a very special communication device was created. This device is called a VDA-Unit™. The VDA-Unit™ is a hand-held unit which consists of a VDA-Module™ in a case with a display screen attached. The onboard color video camera can be designed to swivel. The VDA-Unit™ is capable of also acting as a wireless modem. Currently, it is possible to transfer approximately 30 megabits per second of data through the device as well as video and audio. By miniaturization and employing the addition of a Pulse Digital Signal Processor (PDSP™), other technologies are envisioned. The PDSP™ will add significant speed and stability to the digital transfer in the device. It will also allow to add data compression techniques and make directly, connections to wire or fiberoptics LAN's and WAN's, which are currently handled by a computer interface. The addition of the PDSP™ will improve the technology insertion into other devices. One should be able to reach speeds of 100 megabits per second of raw uncompressed data (patented). This is 400 times faster than the standard 56 k PC modem, and 800 times faster than the current Palm Pilots.

The VDA-Unit™ can be used in any situation where there is a need for short-range, wide-band connectivity, where two-way Video, Data, and Audio are to be exchanged (thus the name VDA™).

This module is capable of different modulation techniques which depend on the data transmitted. If one wants to transmit video, data, and/or audio, it can be done in many different ways. The module is smart enough to discern what type of data comes into it and sets up a preprogrammed modulation that it sends out over the air. The module will not only perform an IM™ modulation, but it will also do FM, AM, SSB, and Spread Spectrum. The module is capable of doing all of the above in one single RF (Radio Frequency) module.

Applicant's VDA-Module™ can modulate AM, FM, IM, or SSB, all in one module. Another plus is that this module is fully duplexed, which means, that it transmits and receives at the same time. In contrast thereto, the “Bluetooth Module” is a simplex module and will receive and transmit in sequence. That is, with the VDA-Module™, one can hear each other and at the same time, see each other in a wireless mode, simultaneously—NOT sequentially or almost simultaneously, but 100% simultaneously and in real time, as long as two operating modules remain in a straight line of sight. There is also another known modulation form called “802.11” which is a specific form of wireless modulation. The VDA™ will also do the “802.11” standard.

This VDA module is capable of different modulation techniques which depend on the data to be transmitted. If one wants to transmit video, data, and/or audio, it can be done in many different ways. The module is smart enough to discern what type of data comes into it and sets up a preprogrammed modulation that it sends out over the air. The module will not only perform an IM™ modulation but it will also do FM, AM, SSB, and Spread Spectrum. The module is capable of doing all of the above in one single RF (Radio Frequency) module.

Applicant's VDA™ module can modulate AM, FM, IM™, or SSB all in one module. Another plus is that this module is fully duplexed, which means that it transmits and receives at the same time. In contrast thereto, the “Blue Tooth module is a simplex module and will transmit and then receive in sequence. That is with the VDA™ module, one can hear each other and at the same time see each other in a wireless mode as long as two operating modules remain in a straight line of sight, so to speak. There is also another known form called “802.11” which is a specific form of wireless. The VDA™ will also do the 802.11 standard.

### OBJECTS OF THE INVENTION

One of the objects of the invention is to create a standard for sending video, data, and audio signals from a wireless device to a network, back to a wireless device. The main object of the VDA Module™ and unit is to convert said signal of video, data, and audio formats into a modulation format and transmit signals wirelessly to a base station, to a network connection in real time. This signal will pass through a device called a PDSP™ (Pulse DSP™—Digital Signal Processor) which is an FPGA (Field Programmable Gate Array) which includes an “802.11” interface or an Ethernet interface. Basically, the IM™ and VDA™ modules will convert any recognized radio frequency signal from the air and convert it to a TCP/IP format and then pass it on to any network. That means, that the IM™VDA-Module™ will be able to plug directly into a TCP/IP network including the Internet and use a wireless device to address the Internet with or without a computer. A VDA Module™ or a VDA Base Station directly attached to a network will receive a signal from a VDA Unit™ and send the signal into the network which in turn will send the digital signal on to another network connection on the other side. The VDA Module™ or base station on the other side will transform the signal to a wireless mode again and the thus transformed signal will wirelessly transmit from the network to another VDA Module™ or unit on that side. Of course, it will transmit the voice and the image of a person over the air. This is all accomplished in a full duplex mode, meaning, the video, data, and audio formats are transmitted simultaneously, in both directions. The module is considered to be the “innards” or the “engine” of the VDA-Unit™.

In this application, applicant will establish a basis for further utility patents:

1) the basic VDA Module™;

2) the basic VDA-Unit™;

3) the connection path;

4) A device located within the basic VDA Module™ called a Pulse DSP™ (PDSP™), which will be built into part of a FPGA™ chip. In addition, the chip is an IP interface and an “802.11” interface. That means that one chip has a TCP/IP interface and PDSPTM. This will create a super fast interface with the network without using a microprocessor, thus saving power in a wireless device by allowing fast data transfer without the use of a microprocessor.

### BRIEF DESCRIPTION OF THE DRAWINGS

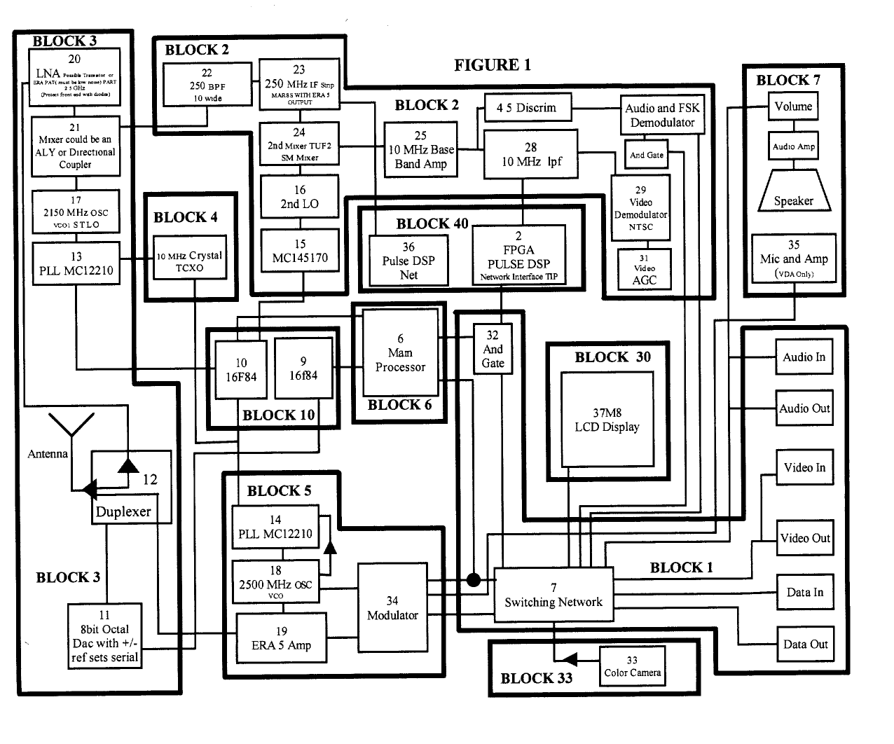

The FIG. 1 is a block diagram of the circuitry of the invention.

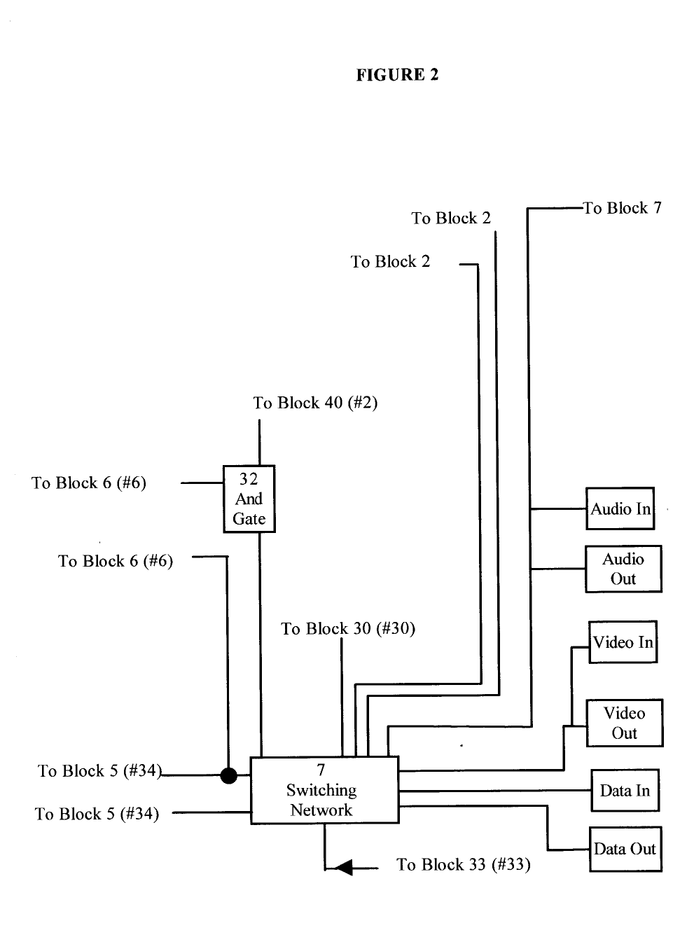

The FIG. 2 is a wiring diagram of Block 1.

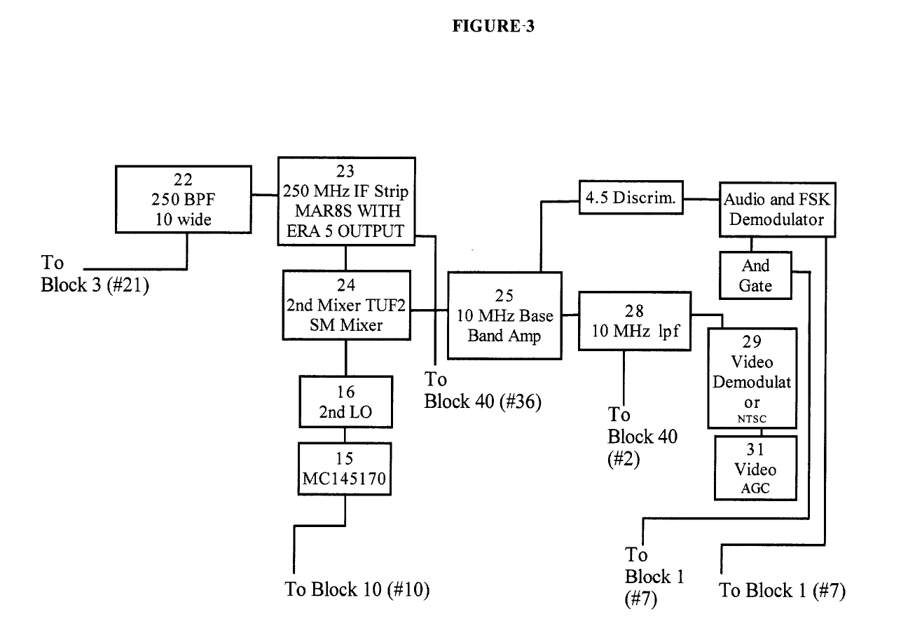

The FIG. 3 is a wiring diagram of Block 2.

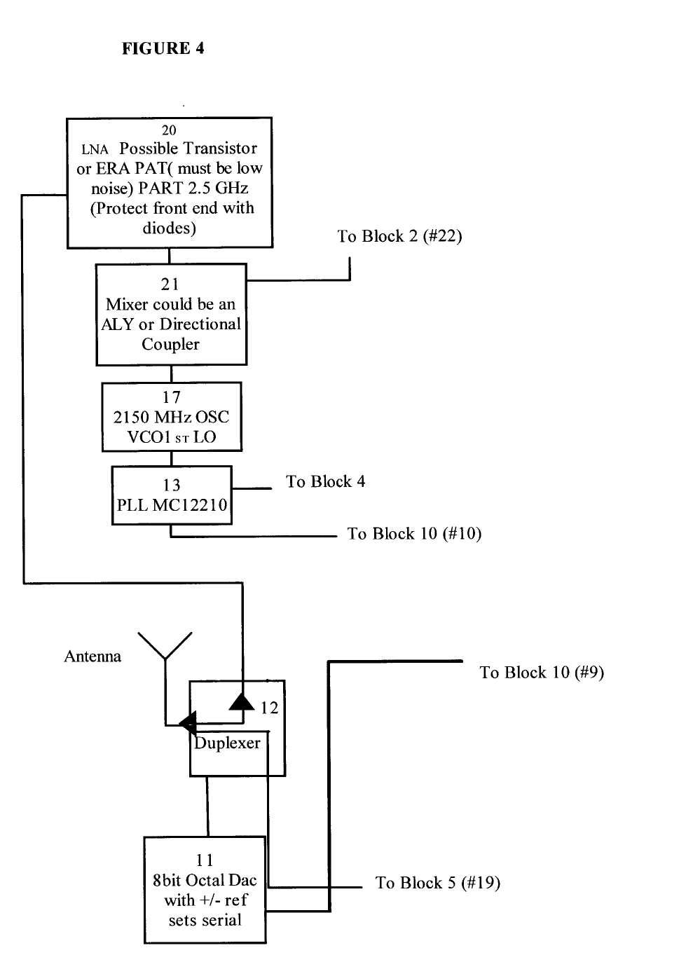

The FIG. 4 is a wiring diagram of Block 3.

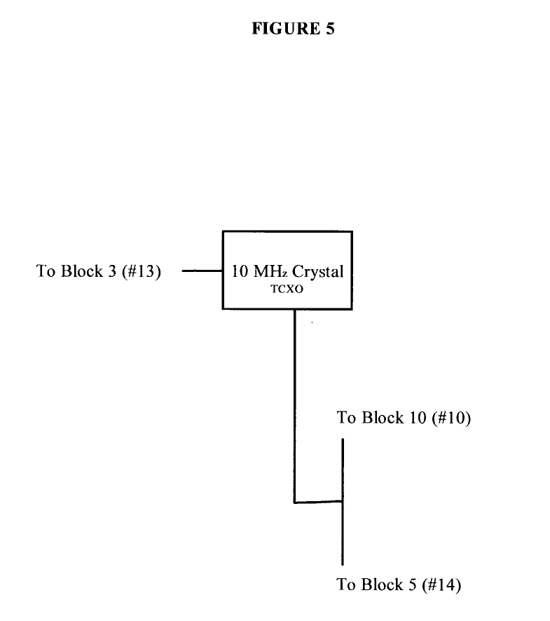

The FIG. 5 is a wiring diagram of Block 4.

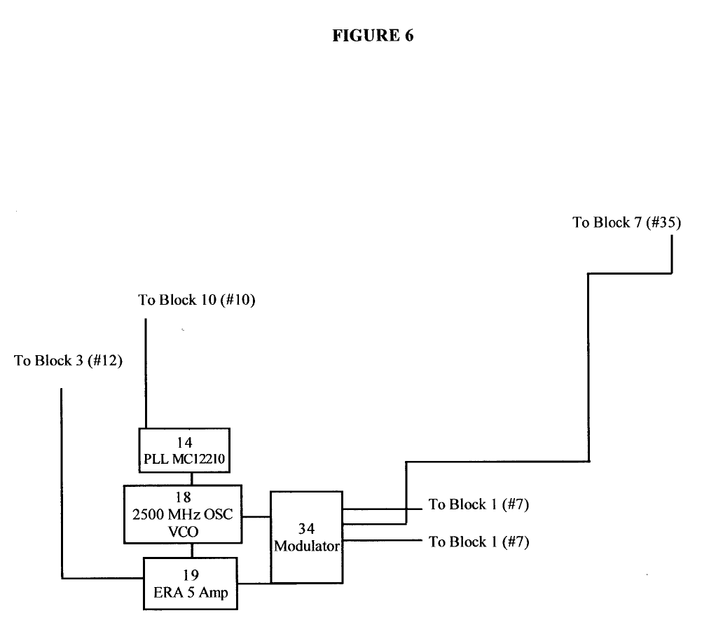

The FIG. 6 is a wiring diagram of Block 5.

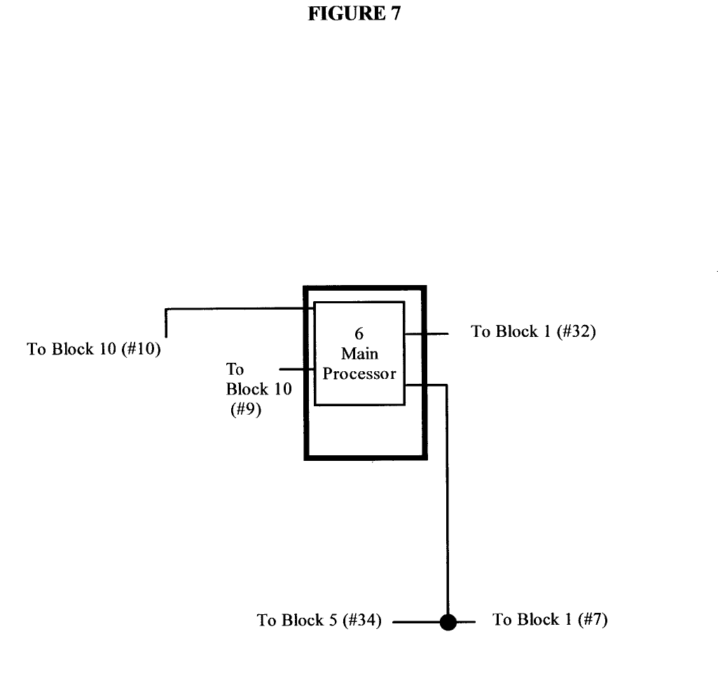

The FIG. 7 is a wiring diagram of Block 6.

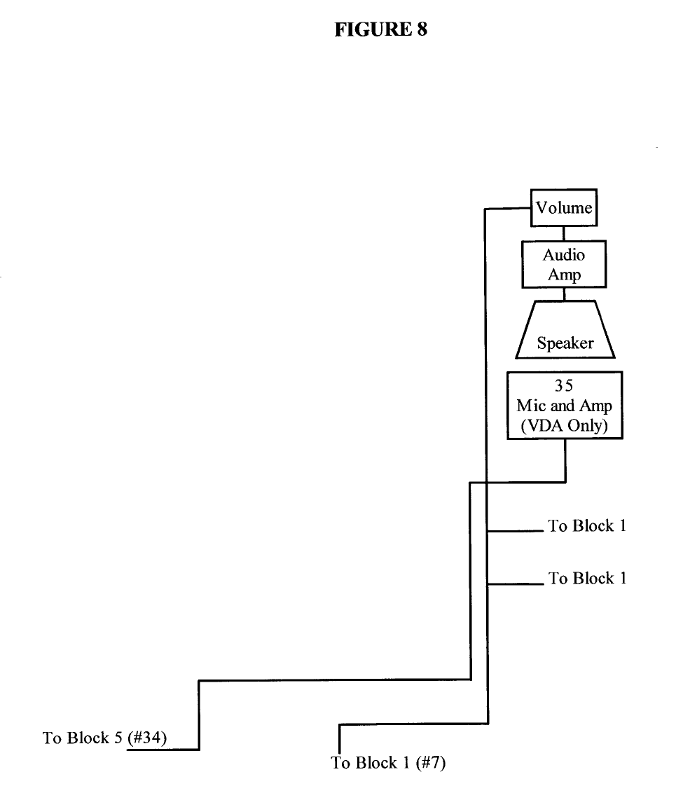

The FIG. 8 is a wiring diagram of Block 7.

The FIG. 9 is a wiring diagram of Block 10.

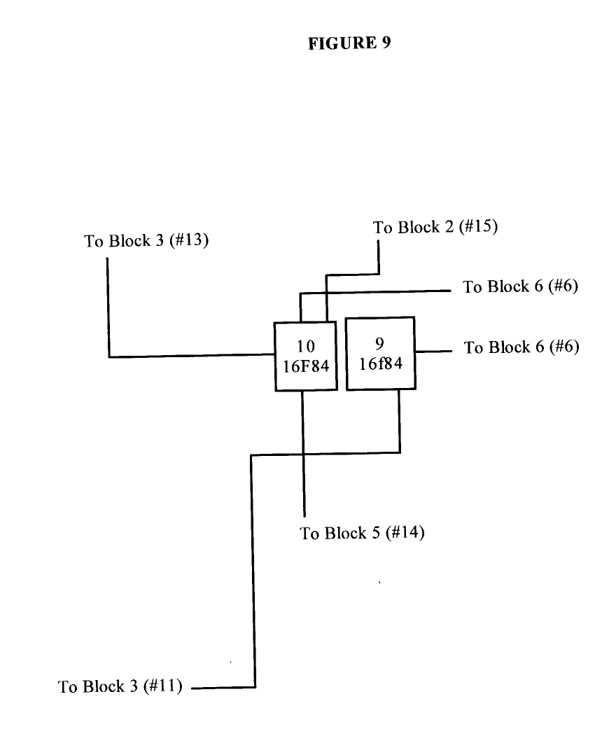

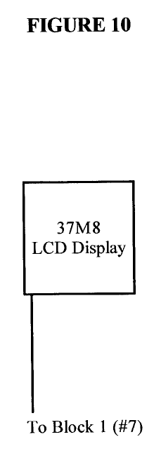

The FIG. 10 is a wiring diagram of Block 30.

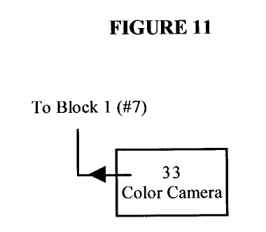

The FIG. 11 is a wiring diagram of Block 33.

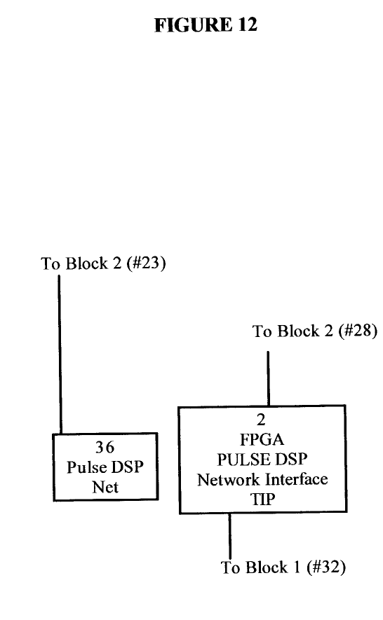

The FIG. 12 is a wiring diagram of Block 40.

### DETAILED DESCRIPTION OF THE INVENTION

In FIG. 1, the block diagram is subdivided into several group blocks which contain individual blocks. The group blocks are identified as 1, 2, 3, 4, 5, 6, 7, 30, 33, and 40. They will be identified again as the description continues.

FIG. 2, Block 1, is the input/output block of the device. It includes all of the connections from and to the module to the outside world. These consist of a keyboard, TCPIP, and 802.11 in a switching network interface, a Pulse DSP, analog video-in/out, audio-in/out, and raw data-in/out. In Block 40, a PDSP™—36 is inserted into the same chip which results in achieving a tremendous speed, whereas most users would use a computer, while in the inventive concept part of a computer is being used which contains the data coming off the radio receiver, in FIG. 3, Block 2, where the signal is cleaned up and then is interfaced with the network. These are some of the special parts of the module. The PDSP™—36, in FIG. 12, Block 40, is a circuit by itself and that is why the unit can go so fast. When using a combination of a PDSP™ with a network interface—2, in FIG. 12, Block 40, it will eliminate the need to use a PC (Personal Computer). Thereby, one is able to plug right into a standard network interface. This setup will decode an IM™ (Interrupt Modulation™) signal which comes off the radio in FIG. 3, Block 2, and being decoded thereby. The PDSP™—36 is a special circuit that decodes frequency signals. This is being represented in FIG. 12, Block 40. The PDSP™ 36 can tap into various points in the radio receiver circuit and it will work as intended. It can go to either the radio network in FIG. 3, Block 2, which has several taps to the PDSP and it will work. The Block 2 in FIG. 3 represents a simple radio receiver where one takes an input signal, mixes it and it becomes an RF signal and then it is mixed again and then one gets a base band signal which is common in most radios. What is unique to the inventive radio is the addition of a PDSP™ with the network interface—2, in FIG. 12, Block 40, the duplexer—12, in FIG. 4, Block 3, and the IF strip in FIG. 3, Block 2. This results in an extremely wide band, low noise and high gain. It needs to have these characteristics to be able to receive an IM™ signal. The mixer—24 mixes the local frequency and the local oscillator and the IF to produce another output. A method of decoding the IM™ (Interrupt Modulation™) would be the use of the PDSP™—36, in FIG. 12, Block 40.

In FIG. 5, Block 4 shows as a temperature controlled crystal oscillator. This device is used as a stable signal reference for all RF, PLL, and digital clocks in the module.

FIG. 6, in Block 5 consists of a transmitter capable of IM/FM/AM/SSB/SS Phase modulation. It is responsible for transmitting all info intended to be sent by the module. The modulator—34, in Block 5, is very special because it can be automatically configured by the main processor—6, of FIG. 7, Block 6, to output a specific type of modulation such as IMTM, FM, AM, SSB and also the Spread Spectrum. The main microprocessor—6, of FIG. 7, Block 6, instructs the modulator—34, of FIG. 6, Block 5, to set up what modulation technique to use in order to pass the data coming from the switching network—17, of FIG. 2, Block 1, to the module. It will also control the input and output from the module.

Block 33 of FIG. 11, is a NTSC or pal mini video camera which is used to collect images into the device. One could also substitute an infrared camera for night-vision or a fiberoptic lens for surveillance. The switching network 7, of Block 1, FIG. 2, sends information from the color camera—33, in Block 33 of FIG. 33. The signal will go into the switching network—7, Block 1 of FIG. 2, and from there will route the signal to the modulator—34, in Block 5 of FIG. 6. The use of FM is the mode of choice to transmit video information. The main processor—6, in Block 6 of FIG. 7, controls all the subsystems and timing. The information from the color camera—33, in Block 33 of FIG. 11, is being routed to the switching network and from there to the modulator. The main processor—6, in Block 6 of FIG. 7, also instructs the modulator what kind of modulation to use. At that point, the modulator—34, in Block 5 of FIG. 6, modulates to RF (Radio Frequency) signal through the amplifiers—19, in Block 5 of FIG. 6, and on to the duplexer—12, in Block 3 of FIG. 4. Turning to the blocks on the right hand side of the drawing in FIG. 8, Block 7 and in FIG. 2, Block 1, all they represent are inputs and outputs, such as data in and data out, video in and video out, audio in and audio out to be passed into or from the module under control of the switching network—7, in Block 1 of FIG. 2. Block 7 also consists of electronics which make up a speakerphone. This allows hands-free video/audio conversations.

Block 30 in FIG. 10 is a device used as a display for video and text information. It is also used as a touch screen keyboard. The LCD display—30, in Block 30 of FIG. 10, also receives information from the switching network—7, in Block 1, so that the LCD display—30, in Block 30 of FIG. 10, can display the inputs or outputs of the kind of information that is coming in or out of the module which is an attachment to the LCD display (not shown). The color camera 33, in Block 33 of FIG. 11, and the microphone and amplifier—35, in Block 7 of FIG. 8, are operating in VDA-Unit™, see FIGS. 8 and 11. If these three components are added to a module, a VDA-Unit™ is created.

In FIG. 4, Block 3 is the front end of the receiver of the module. The receiver's front end is similar to most receivers' front end with the exception of a special filter/duplexer—12. This device along with the octal DAC digital to analog converter—11, is what allows the VDA module to be duplexed. It channels the receive information and the transmit information to share the same antenna, but improves over the prior art by automatically tuning the front end of the receiver and the output of the transmitter by use of specific tuning diodes in conjunction with the micro-controller in Block 10. This system re-tunes the unit to operate on the desired frequencies automatically without manual tuning of most duplexers. It also sets the bandwidth of the incoming RF signals into the module acting as an adjustable bandwidth device. Every time the receiver and the transmitter change channels, this processor in Block 10 of FIG. 9, evaluates the tuning of the front end to the antenna in Block 3, of FIG. 4, and it also separates the paths from the transmitter to the receiver into the antenna. It will operate the channel and the processor—6, in Block 6 of FIG. 7, will instruct the 8 bit octal dac—11, in Block 3 of FIG. 4, to set up the duplexer—12, in Block 3 of FIG. 4, to make the receive signal to pass to the receiver and to pass the transmitter signal to pass over to the antenna. These are two different frequencies. The signal 19, from Block 5 of FIG. 6, may transmit with a frequency of 2486 MHz and the other receive signal may come in with a frequency of 2400 MHz. The duplexer—12, in Block 3 of FIG. 4, automatically splits up the signals on the front end from the antenna and it re-tunes the output of the transmitter to antenna. Assuming that channel “one—the receiver” uses 2400 MHz and channel “two—the transmitter” uses 2425 MHz, the duplexer—12, in Block 3 of FIG. 4, and the 8 bit octal dac—11, in Block 3 of FIG. 4, will operate together to optimize the receiver to receiver on 2400 MHz and to optimize the transmitter to transmit on 2486 MHz.

The user changes the channel and as a result the duplexer—12, in Block 3 of FIG. 4 re-tunes itself to now operate at 2425 MHz and it re-tunes itself as well to operate on 2475 MHz without any manual intervention. The front end of the apparatus is automatically re-tunable. This is quite helpful and is a tremendous asset to the inventive concept because of the narrow banding of the front end. Any radio transceiver unit needs this kind of a device to properly work well in a duplexed situation. It is an automatic antenna tuner and duplexer all in one unit. It also works in the microwave frequencies range. Other known devices are out there in the field with an automatic antenna tuner that just tunes the receiver while another device has to tune the transmitter. None are available wherein the duplexer as well as a front end tuner split up the path of the transmitter and the receiver signals to the antenna that are all contained in one unit and are automatically engaged. The unit will split up the path of the transmit and receive signals automatically. Most of the time in a conventional duplexer is a fixed entity because it is tuned once and that is the end of it. The VDA™ duplexer not only retunes but it actually provides the tuning for the front end of the radio. Because of the fact that a multiple of frequencies are involved and every time a channel is changed, the duplexer re-tunes automatically. The Block 10 of FIG. 9 unit has two small microprocessors, 9 and 10. In Block 10 of FIG. 9, 9 is a microcontroller in charge of the duplexer—12, in Block 3 of. 4, and the 8 bit octal switches—11, and Block 3 of FIG. 4, which is a digital to analog converter. In Block 10 of FIG. 9, 9 also controls 11 in Block 3 of FIG. 4, and 11 controls 12 also in Block 3 of FIG. 4, and the main control comes from main processor—6, in Block 6 of FIG. 7, which controls 9 in Block 10 of FIG. 9. In Block 6 of FIG. 6, 6 also controls 10 in Block 10 of FIG. 9, which instructs 13 in Block 3 of FIG. 14, 14 in Block 5 of FIG. 6, and 15 in Block 2 of FIG. 3. In Block 10—10 as a microprocessor in charge of controlling the PLL (Phase Lock Loop) 15 in Block 2 of FIG. 3. In Block 10 of FIG. 9, 10 also controls the frequency of the PLL—13, in Block 3 of FIG. 4, PLL 14, in Block 5 of FIG. 6, and the PLL—15, in Block 2 of FIG. 3. Of these PLL's, PLL—14, in Block 5 of FIG. 6, directly sets the transmitter frequency. In Block 3 of FIG. 4, 13 sets the receiver frequency and in Block 2 of FIG. 3, 15 sets the 2^{nd} local oscillator's frequency. 16, also in Block 2 of FIG. 3, 17 in Block 3 of FIG. 4, and 18 in Block 5 of FIG. 6 are all devices called VCO (Voltage Controlled Oscillators). These VCO's create the fundamental frequency that goes out over the air and what is being received. To this end, what happens is that 10 in Block 10 of FIG. 9, instructs 14 in Block 5 of FIG. 6 to “make the 18 in Block 5 of FIG. 6 set up at 2500 MHz” and then to keep it there. 10 in Block 10, of FIG. 9 also instructs 18 in Block 5 of FIG. 6 to lock in at a specific frequency. Now, the PLL—14, in Block 5 of FIG. 6, locks the VCO—18, in Block 5 of FIG. 6, on this specific frequency. The output—18 from Block 5 of FIG. 6 is now passed to 19 in the same Block, is amplified, and from there is routed to the duplexer 12, in Block 3 of FIG. 4, over the air. In Block 5 of FIG. 6, 19 is simply an amplifier. In Block 10 of FIG. 9, 10 instructs the PLL—13, in Block 3 of FIG. 4 what to do and then sets up the VCO—17, also in Block 3 of FIG. 4 at a specific frequency so that the incoming signal can be mixed to create a first intermediate signal.

Block 2 of FIG. 3 is the IF section of the module. This IF section features an intermediate frequency amp with an automatic gain control with 70 dB of gain, controlled by Block 10 of FIG. 9, a small micro-controller which is responsible for setting the LO (local oscillator) frequency of the IF strip. In Block 2 of FIG. 3, the incoming signal comes from 20 in Block 3 of FIG. 4. In Block 3 of FIG. 4, 20 and 17 are two signal sources that will be mixed in 1 and the result of that creation of an output that is passed to 22 in Block 2 of FIG. 3 as the first IF (Intermediate Frequency). The first IF is now passed to 23 also in Block 2 of FIG. 3, where it will be amplified and then mixed with 24. That is, 23 and 16 in Block 2 of FIG. 3 are mixed together to produce another frequency which is called the 2^{nd} IF or Intermediate Frequency at 25. What happened is that a large section of the frequency, such as channel “one—RF Frequency” at 2400 MHz was taken when coming out on 20 in Block 3 of FIG. 4 and was then mixed with the 2150 MHz frequency coming from 17 also in Block 3 of FIG. 4 and thereafter having outputs at 250 MHz because it passes through the band-pass-filter—22 in Block 2 of FIG. 3 and then is passed on to the IF strip 23 also in Block 2 of FIG. 3 where the signal is being amplified. Once the signal passes through the IF strip—23 in Block 2 of FIG. 3, it is being re-routed and mixed with the signal at 16. At 16 in Block 2 of FIG. 3, the signal will be at a frequency of 240 MHz which will then produce an output band-pass-frequency of 10 MHz at 25 in Block 2 of FIG. 3, after mixing at 24, also in Block 2 of FIG. 3. From there, the signal—25 will be passed directly to Block 1 of FIG. 2 for either a V, D, or A use. Alternatively, both the IF or base band signal could be processed further in a PDSP™ and the network interface—2, in Block 40 of FIG. 12. An alternative scenario would be to process the signal further even before it is being mixed to come out of 23 in Block 2 of FIG. 3 into a PDSP™—36 in Block 40 of FIG. 12 to provide a high speed data directly into a network interface. If the user would be using a module to interface with a network, the user would be using the above-described path

If a module is being used in a VDA Unit™, then further processing is needed because the display has to be energized and the signal—25 has to pass through Block 2 of FIG. 3 to another PDSP™—36 in Block 40 of FIG. 12, which signal will then be used by the main processor—6, in Block 6 of FIG. 7 and the signal would go through a Video demodulator—29, in Block 2 of FIG. 3, and would be displayed on Block 30 of FIG. 10. If the path (Block 1), FIG. 2 method is being used, that is how one would interface a module to a network. If a module is being used in a VDA-Unit™, one would take the path—25 through Block 2 of FIG. 3 on to the low-pass filter 28, on to 29 into 31—the Video AGC (Automatic Gain Control) to make sure that the video signal stays at a certain level automatically. The video signal is then passed on through the switching network—7, in Block 1 of FIG. 2 to the display in Block 30 of FIG. 10. That is how the signal is being received or as an alternative directly routed through Block 1 of FIG. 2. It is noted that there are not necessarily two PDSP's ™ in this apparatus. The route to these can be switched by a simple gate—32, Block 1 of FIG. 2. It is also to be noted that the signals at the network level are all in a digital format, (0's and 1's). At the display level it is desirable to use the NTSC video standard. What is special to the module is that it automatically adapts to different modulations and formats. The processor—6, in Block 6 of FIG. 7 has special software incorporated therein that identifies what to do in different scenarios. When it receives the IM™ modulation it realizes that this format is strictly in data. When it intercepts a video FM transmission in a NTSC format, it realizes that it is a FM transmission and it now switches the switching network so that the LCD display, Block 30 of FIG. 10 applies, that is, from 6 in Block 6 of FIGS. 7 to 7 in Block 1 of FIGS. 2 to 28 in Block 2 of FIGS. 3 to 29 and on to Block 30 of FIG. 10. The main processor 6 in Block 6 of FIG. 7 can also tell and act accordingly when it does not want to send the signal to Block 30 of FIG. 10, but instead sends it back out to a video port on the chip. The switching network instructs the radio receiver output and the transmitter input to control where the signal goes and where it comes from. This is what the switching network does.

Block 6 of FIG. 7 is the main microprocessor. This device controls all high level functions of the device including running software for mp3, word processing, operating system, display processing (display video), and user interface touch-screen. The main processor is used to implement IMRC Technologies, Inc.'s proprietary variable data packet protocol which consists of first-the address of the sending device, second-the address of the destination, third- any control data for internal use, fourth-actual data to be sent, fifth-options, and sixth-end of packet command. This protocol is used for internal communications in a VDA network system. It instructs all the different group blocks in the drawing what to do. There is firmware in the main processor—6, in Block 6 of FIG. 7, it would develop all the different instructions. Whereas an FPGA™—2, in Block 40 of FIG. 12 is the same physical size as the size of the main processor—6, Block 6 of FIG. 7 but the FPGA™—2, Block 40 of FIG. 12 does not run on instructions; it is a piece of hardware. It would do all the various functions at the same time, whereas a microprocessor has to do one function at a time, it follows instructions.

In Block 40 of FIG. 12, a Pulse DSP™ 36 and 2, will take instructions and run multiple functions at a time. In contrast thereto, a microprocessor can only do one function at a time. The PDSP™—36, in Block 40 of FIG. 12 can do multiple functions at the same time and at the exact same time. All these scenarios are built into the chips internally which chips are incorporated in the overall apparatus.

What I claim is:

1. A method of using IM and VDA modules to convert all recognized modulation types of radio frequency signal coming in from the air and convert it to a TCP/IP packet format and then pass this onto any network.

2. A method of transmitting video, data, and audio signals from a handheld first station to a hand-held second station in a full duplex mode through a network comprising the steps of: converting original signals of and in said hand-held first station to radio frequency signals by passing said signals through a Video-Data-Audio-Module, transmitting said signals to another VDA Module in a base station by a Pulse DSP in said module, passing said signals through a network, from said network passing said signals to a Video-Data-Audio-Module in said second base station, converting to radio frequency signals and then transmitting said original signals to a hand-held video-data-audio unit in said second hand-held station, displaying the results, and then reversing the method in the opposite direction simultaneously.

3. A method of transmitting original video, digital data, and audio signals from a first hand-held station to a second hand-held station, in a full duplex mode comprising the steps of: converting said original video, digital data, audio signals into radio frequency signals, sending said radio frequency signals through the air to a second hand-held station receiving said radio frequency signals while converting said radio frequency signals back to their original state of signals while converting said radio frequency signals while at the same time transmitting said signals in an opposite direction accounting for a full duplexing of all of the signals.

4. A method of wirelessly transmitting and receiving video, data, and audio signals in a full duplex mode from a hand-held first station to a second hand-held station comprising the steps of first transmitting said signals from a video, data, and audio module in said first handheld station to a video, data, and audio module in said second handheld station or to base station or transmitting said signals from said video, data, and audio signals from said hand-held first a video, data, and audio base station through a digital network to a second base station and from there to a second video, data, and audio unit.

5. The method of claim 3 including the step of identifying each individual video, data, and audio module or video, data, and audio unit by programming an address into each VDA Module. Said address will then synchronize itself with a user's name and his IP address

6. The method of claim 3 including the step of setting the video, data, and audio unit to act as a wireless modem.

7. The method of claim 3 including the step of transmitting said video, data, and audio signals through an internal or intranet connection, instead of the conventional hand-held radio/tower scenario.

8. A hand-held video, data, and audio module having means of discerning any type of different, video, data, and audio signals coming into said module and further having means for setting up a preprogrammed modulation to send out over the air including means for manipulating interrupt modulation and pulse DSP demodulation.

9. The module of claim 8 including means for modulating AM, FM, IM, and SSB.

10. The module of claim 8 including means for fully and automatically duplexing in real-time, the receiving and the transmitting of the data being sent out from point A to point B simultaneously over the air in a hand-held unit.

11. A method of transmitting and receiving signals that have a digital throughput in bits/second to equal with whatever the carrier frequency is, such as for example, the carrier frequency is 2.4 GHz which is equal to 2.4 Gbit of digital data thruput.

12. A method of using a video, data, and audio module in sending and receiving signals comprising the steps of: using interrupt modulation and frequency modulation for transmitting and using a pulse digital signal processor demodulation and frequency discrimination for receiving.

13. An apparatus for manipulating video, data, and audio signals including a video, data, and audio module, a color camera, a display unit, a duplexer, and a power unit all combined into one hand-held unit.

14. A hand-held video, data, and audio unit having means for sending and receiving all types of video, digital data, and audio signals, further having means for sending IM, FM, AM, and SSB signals including additional means of receiving pulse DSP, FM discrimination and single side band signals.

15. A method of operating a hand-held video, data, and audio unit comprising the step of entering control data by way of a built in keyboard.

16. A method of operating a hand-held video, data, and audio unit comprising the step of entering control data by way of a built in touch screen.

17. A method of operating a hand-held video, data, and audio unit comprising the step of entering control data by way of a built in voice recognition.

18. The method of claims 15, 16, and 17, wherein said control data sent over the air has the address of the sending video, data, and audio unit, the address of the receiving video, data, and audio unit, the command of what action is to be performed including additional option commands and finally, the end of the information packet command format or protocol.

19. A method of using short-range fully duplexed radio transmissions in the microwave region to send and receive ultra fast video, data, and audio transmissions using a VDA Module.

20. A VDA Module uses RF and digital error correction method enable by interrupt modulation and pulse DSP performed by hardware instead of software, relieving upper layer software of the job.

21. A method of tuning the front end of a receiver automatically, while tuning the output stage of the transmitter automatically and simultaneously using the automatic duplexer, block 12.
